(19) United States
(12) Patent Application Publication
(10) Pub. No.: US 2008/0073569 A1
(43) Pub. Date: Mar. 27, 2008

(54) Mask position detection

(75) Inventors: Charles A. Teodorczyk, Danville, NH (US); James R. McLane, Beverly, MA (US); Robert Andrew Poitras, Beverly, MA (US)

Correspondence Address: VARIAN SEMICONDUCTOR EQUIPMENT ASSC., INC., 35 DORY RD., GLOUCESTER, MA, 01930-2297, US

(73) Assignee: Varian Semiconductor Equipment Associates, Inc., Gloucester, MA (US)

(21) Appl. No.: 11/525,567

(22) Filed: Sep. 23, 2006

(51) Int. Cl. G01N 23/00

(52) U.S. Cl. 250/491.1

(57) ABSTRACT

A system includes a transfer arm defining a retaining plane, and at least three sensors are disposed on the transfer arm and configured to detect a position of a mask relative to the retaining plane. The at least three sensors may be used to determine if the mask is properly positioned on the transfer arm and to determine if the mask is properly positioned in a masking position. The mask may be used in an ion implanter to shield portions of a workpiece from ion implantation.

### FIELD

This disclosure relates to processing of workpieces with a mask and, more particularly, to an apparatus and method for detection of a position of the mask.

### BACKGROUND

An ion implanter may utilize a mask to shield a portion of a workpiece from ion implantation while allowing other portions of the workpiece to be implanted with ions through an aperture in the mask. Thus, the ion implanter will only implant ions into the exposed area of the workpiece. By precisely masking portions of the workpiece, multiple implantations may be done on a single workpiece instead of on multiple workpieces. This shortens time required to determine optimum process or device parameters, utilizes fewer workpieces, and reduces the impact of workpiece-to-workpiece variation in design of experiments (DOE) in research and development facilities. Consequently, masking of workpieces can significantly reduce the cost of developing new technology.

The mask may be initially retained on a transfer arm of a mask transport system for transport between different positions. Although physically coupled on the transfer arm, the mask may be improperly engaged with one or more associated retaining elements. Thus, the mask may inadvertently disengage from the transfer arm during transport causing potential damage to the mask. In addition, the transfer arm may also have difficulty properly positioning the mask in desired positions if it is not first properly positioned on the transfer arm.

The transfer arm of the mask transport system may also drive the mask between a non-masking position and a masking position. The non-masking position may be a storage location where the mask has no effect on ions implanted into the workpiece. The masking position may be in front of the workpiece and hence the platen. Once the mask is physically secured in front of the platen, a conventional ion implanter assumes the mask is in a proper masking position. However, the mask may be incorrectly engaged with one or more associated mask retaining elements and therefore not in the proper masking position. This may then lead to deviation from the intended implant area of the workpiece.

Accordingly, there is a need in the art to determine if the mask is properly positioned on the transfer arm for transport and if the mask is properly positioned in the masking position.

### SUMMARY

According to a first aspect of the invention, a system is provided. The system includes a transfer arm defining a retaining plane, and at least three sensors disposed on the transfer arm and configured to detect a position of the mask relative to the retaining plane.

According to another aspect of the invention, an ion implanter is provided. The ion implanter includes an ion generator configured to generate ions and direct the ions towards a workpiece, a platen configured to support the workpiece, a transfer arm defining a retaining plane, and at least three sensors disposed on the transfer arm and configured to detect a position of a mask relative to the retaining plane.

According to yet another aspect, a method is provided. The method includes transporting a transfer arm defining a retaining plane into contact with a mask, the transfer arm having at least three sensors disposed thereon, and monitoring a condition of the at least three sensors to detect a position of the mask relative to the retaining plane.

### BRIEF DESCRIPTION OF THE DRAWINGS

For a better understanding of the present disclosure, reference is made to the accompanying drawings, which are incorporated herein by reference and in which:

FIG. 1 is simplified block diagram of an ion implanter including a mask transport system consistent with the invention;

FIG. 2 is a plan view of the mask of FIG. 1;

FIG. 3A is a simplified schematic block diagram of a mask properly positioned on a transfer arm;

FIG. 3B is a simplified schematic block diagram of a mask not properly positioned on the transfer arm;

FIG. 4A is a simplified schematic block diagram of the transfer arm extended from a mask in a proper masking position;

FIG. 4B is simplified schematic block diagram of a mask properly positioned in a masking position with the transfer arm extended to the mask;

FIG. 4C is a simplified schematic block diagram of a mask not properly positioned in a masking position with the transfer arm extended to the mask;

FIG. 5 is a perspective view of one mask position detection apparatus consistent with an embodiment; and

FIG. 6 is a simplified block diagram of one embodiment of the sensors disposed on the transfer arm.

### DETAILED DESCRIPTION

The apparatus is described herein in connection with an ion implanter. However, the apparatus can be used with other processes involved in manufacturing that use a mask, such as plasma immersion, chemical vapor deposition, physical vapor deposition, or other processes known to those skilled in the art that utilize masking. Thus, the invention is not limited to the specific embodiments described below.

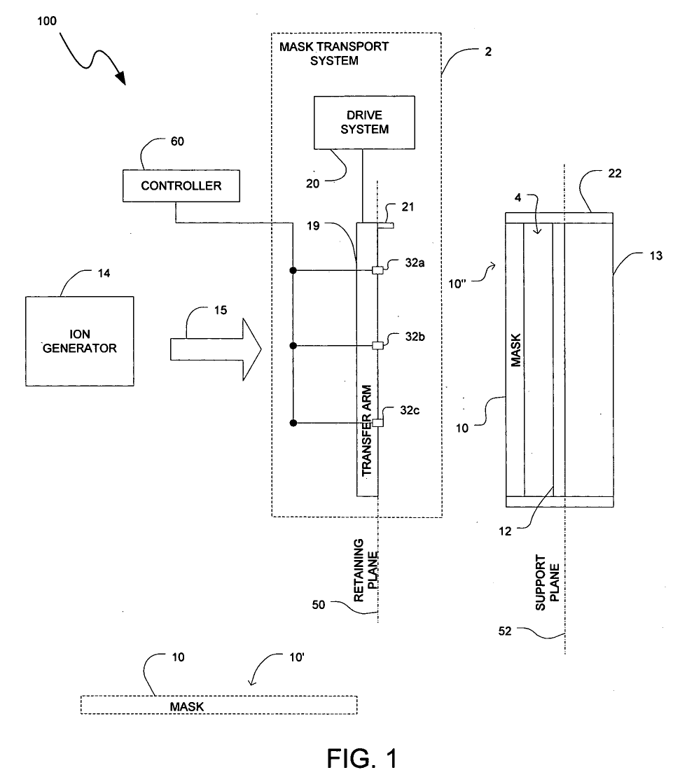

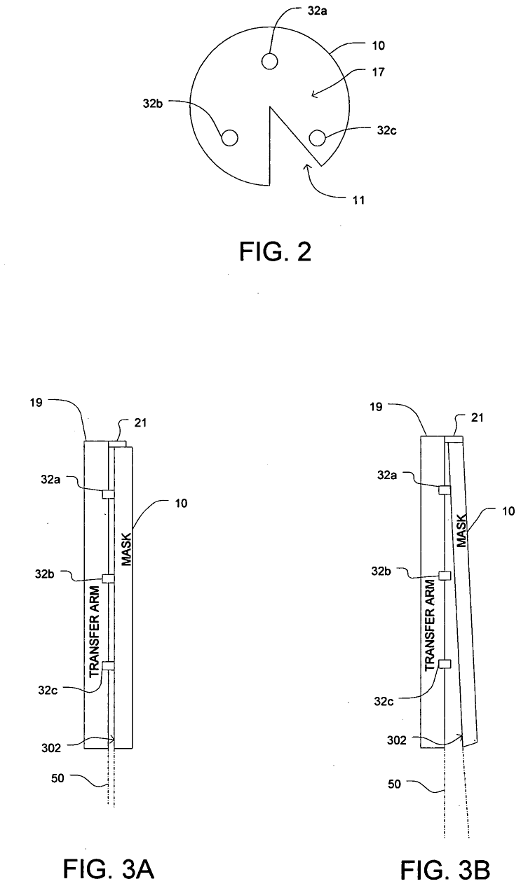

A block diagram of an ion implanter 100 in accordance with an embodiment of the invention is illustrated in FIG. 1 and FIG. 2 is a plan view of the mask 10 of FIG. 1. The ion implanter 100 may include an ion generator 14 configured to generate ions 15 and direct the ions towards a workpiece 12. The ion implanter 100 may be a beam-line ion implanter where the ions 15 are disposed in a well-defined ion beam or the ion implanter 100 may be a plasma doping ion implanter. The ion implanter 100 may be a single wafer ion implanter or a batch ion implanter as are known in the art.

The ion implanter 100 may further include a mask transport system 2, a platen 13 to support a workpiece 12, and a controller 60. The mask 10 may be circular or other geometries and one embodiment of a circular mask 10 is illustrated in FIG. 2. The mask 10 has an aperture 11 to permit the passage of ions 15 to certain portions of the workpiece 12 and a blocking portion 17 to block the ions from reaching other portions of workpiece 12. Thus, ions only implant the workpiece 12 in the area defined by the aperture 11. It will be understood to those skilled in the art that the implanted area of workpiece 12 may exhibit edge effects in a region near the boundary of the aperture 11.

The aperture 11 of FIG. 2 is a sector-shaped aperture of a circular mask. However, a mask may have one or more apertures of differing geometries. For example, an aperture may be located within a blocking portion 17 of the mask 10 so that the aperture is surrounded by the blocking portion 17. In another embodiment, the aperture may be partially surrounded by the ion blocking portion 17. Thus, the aperture may have an interior location on the mask 10 or may be located at the edge of the mask 10.

The mask 10 can be fabricated of a conductive material that minimizes contamination of the workpiece being implanted such as, for example, carbon fiber, silicon carbide, silicon, or graphite. As an example, a carbon fiber mask can have a thickness of 0.090 inch. In one specific example, the aperture 11 may have a relatively sharp edge at the boundary between the mask material and the aperture 11.

The mask transport system 2 may include a transfer arm 19 and a drive system 20. The transfer arm 19 is configured to retain and transport the mask 10. One or more retaining elements 21 of the transfer arm 19 may engage the mask 10 to retain the mask 10 on the transfer arm 19. The retaining element 21 may be mechanically activated or may be a fixed structure. The transfer arm 19 also defines a retaining plane 50. The drive system 20 may include motors, gear trains, linkages, and other components known in the art to drive the transfer arm 19 and hence the mask 10 when the mask 10 is retained on the transfer arm 19. At least three sensors 32a, 32b, and 32c are disposed on the transfer arm 19 and are configured to detect a position of the mask 10 relative to the retaining plane 50.

The sensors 32a, 32b, 32c may be equally spaced from each other in a triangular, circular, or other non-linear pattern. The sensors 32a, 32b, 32c may also be varying distances from each other in such patterns. The sensors 32a, 32b, 32c may be switches that when contacted by the blocking portion 17 of the mask 10 are activated to changes states. The switches, e.g., sub-miniature snap action switches in one embodiment, may have an open and closed position that is activated to change states when contacted. The sensors 32a, 32b, 32c may also be an electrical circuit having an open and closed state.

The sensors 32a, 32b, 32c may be configured to verify connections from the sensors to the controller 60. For example, one of the sensors 32a may be in a closed state when not contacted by the mask 10. The other two sensors 32b and 32c may be in an open state when not contacted by the mask 10. Thus, when the three sensors 32a, 32b, 32c are not in contact with mask 10, the sensors 32a, 32b, 32c would read one closed and two open. However, when the three sensors 32a, 32b, 32c are in contact with mask 10 in a proper masking position, the three sensors 32a, 32b, 32c would be activated to changes states to two closed and one open. This embodiment allows detection of when the three sensors 32a, 32b, 32c are not properly connected to the controller 60. For example, having all three sensors 32a, 32b, 32c in a closed state when not in contact with the mask 10 may give the same reading as three sensors 32a, 32b, 32c that have been inadvertently disconnected, or are otherwise not functioning correctly. Having one sensor 32a read opposite of the other two sensors 32b, 32c may allow confirmation that all three sensors 32a, 32b, 32c are connected and functioning.

Relative positions of the mask 10 and the workpiece 12 may be changed to implant different areas of the workpiece 12 through the aperture 11. The repositioning may be performed through re-orienting the workpiece 12, the mask 10, or both the workpiece 12 and the mask 10. In another embodiment, different masks may be used to implant different areas of the workpiece 12.

The mask transport system 2 may transport the mask 10 to and between a non-masking position 10′ and a masking position 10″. A non-masking position 10′ may be a storage location where the mask 10 has no effect on ions 15 implanted into the workpiece 10. The storage location may be inside or outside the process chamber. The masking position 10″ may be upstream from the workpiece where upstream and downstream are referenced in the direction of ion flow. In a proper masking position 10″, a surface of the mask is parallel with a support plane 52 defined by the front surface of the platen 13 that supports the workpiece 12.

The workpiece 12 may be a semiconductor wafer having a common disk shape. The mask 10 may be transported to the masking position 10″ and then retained in the masking position 10″ by one or more mask retaining elements 22. In one embodiment, the mask 10 may be spaced from a front surface of the platen 13 forming a gap 4 of sufficient size to permit a workpiece 12 to be loaded and unloaded from the platen 13 without contacting the mask 10. The workpiece 12 may be clamped to the platen 13 using known techniques, e.g., electrostatic wafer clamping where the wafer is clamped to the platen with electrostatic forces.

The controller 60 may include a general-purpose computer or network of general-purpose computers that may be programmed to perform desired input/output functions. The controller 60 may also include a processor and a machine readable medium. The processor may include one or more processors known in the art such as, for example, those commercially available from Intel Corporation. Machine readable medium may include one or more machine readable storage media, such as random-access memory (RAM), dynamic RAM (DRAM), magnetic disk (e.g., floppy disk and hard drive), optical disk (e.g., CD-ROM), and/or any other device that can store instructions for execution. The controller 60 may also include user interface devices such as touch screens, user pointing devices, displays, printers, etc. to allow a user to input commands and/or data and/or to monitor the ion implanter 100. The controller 60 may receive input data and instructions from any variety of systems and components including the sensors 32a, 32b, 32c, and may provide output signals to control other components of the ion implanter 100 in response thereto.

Turning to FIGS. 3A and 3B, simplified schematic block diagrams of the transfer arm 19 and the mask 10 are illustrated showing the mask 10 properly positioned on the transfer arm 19 (FIG. 3A) and an example of the mask 10 not properly positioned on the transfer arm 19 (FIG. 3B). The sensors 32a, 32b, 32c may be positioned in a pattern consistent with that illustrated in FIG. 2. In operation, the transfer arm 19 of the mask transport system 2 is driven by the drive system 20 to initially retain the mask 10 on the transfer arm 19 for transport from the non-masking position 10′ to the masking position 10″. One or more mask retaining elements 21 may engage the mask to retain the mask 10 on the transfer arm 19. In some embodiments, the mask 10 may have one or more fingers that engage the mask retaining elements 21.

When the mask 10 is properly engaged with the one or more retaining elements 21, a surface 302 of the mask 10 is parallel to the retaining plane 50 as illustrated in FIG. 3A. The mask 10 should also be positioned relative to the sensors 32a, 32b, 32c so that at least three sensors should be simultaneously activated by the blocking portion 17 of the mask 10 (e.g., see FIG. 2) if the mask 10 is properly positioned on the transfer arm 19 as illustrated in FIG. 3A. The controller 60 may then receive a signal from the sensors 32a, 32b, 32c representative of proper positioning of the mask 10 on the transfer arm 19. In FIG. 3A, the mask 10 is illustrated as touching only the sensors 32a, 32b, 32c for clarity of illustration. However, the mask 10 may contact the transfer arm and be supported by the surface defining the retaining plane 50 as the sensors 32a, 32b, 32c are depressed into associated cavities by the mask 10.

When the mask 10 is not properly engaged with the one or more retaining elements 21, the surface 302 of the mask 10 is not parallel to the retaining plane 50 as illustrated in FIG. 3B. In this instance, the sensors 32a, 32b, 32c are not simultaneously activated when the mask 10 is retained on the transfer arm 19. The controller 60 may then receive a signal from the sensors 32a, 32b, 32c representative of improper positioning of the mask 10 on the transfer arm 19. The controller 60 may then instruct components to take corrective action including, but not limited to, keeping the mask in the non-masking position 10′ and reattempting to retain the mask on the transfer arm 19, activating an alarm to notify users after multiple unsuccessful attempts to retain the mask on the transfer arm 19, and prohibiting transport of the mask 10 to the masking position 10″ until it is successfully retained by the transfer arm 19.

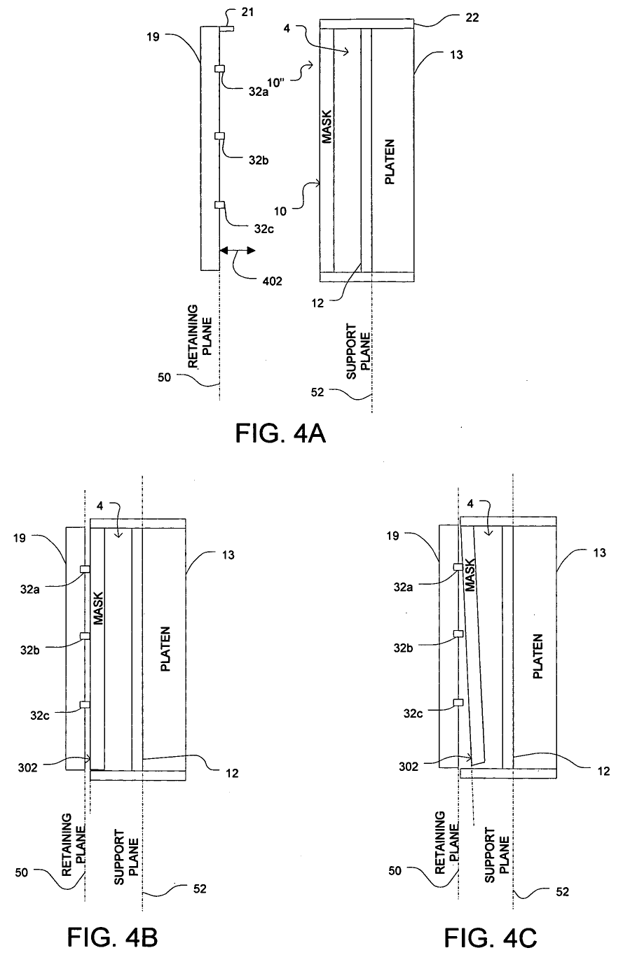

Turning to FIGS. 4A-4C, simplified schematic block diagrams of the transfer arm 19 and the mask 10 are illustrated showing the mask 10 properly positioned in a masking position (FIG. 4B) and an example of the mask 10 not properly positioned in the masking position (FIG. 4C). The sensors 32a, 32b, 32c may be positioned in a pattern consistent with that illustrated in FIG. 2. In operation, the transfer arm 19 of the mask transport system 2 is driven by the drive system 20 to transport the mask 10 to the making position 10″ from the non-masking position 10′. One or more mask retaining elements 22 may engage the mask 10 or portions thereof, e.g., fingers of the mask, to support the mask. In one embodiment, the mask 10 may be spaced from a front surface of the platen 13 forming a gap 4 of sufficient size to permit a workpiece 12 to be loaded and unloaded from the platen 13 without contacting the mask 10.

Once the mask 10 is physically coupled to the one or more mask retaining elements 22, the transfer arm 19 may then be retracted and extended by the drive system 20 in a direction indicated by arrows 402. The transfer arm 10 may be retracted a short distance so that all the sensors 32a, 32b, 32c no longer contact any portion of the mask 10. The transfer arm 19 may then be extended back towards the mask 10 until it contacts a portion of the mask 10 to determine if the mask 10 is properly positioned in the masking position.

FIG. 4B illustrates the transfer arm 19 extended to the mask 10 when the mask is in the proper masking position. The mask 10 is illustrated as touching only the sensors 32a, 32b, 32c for clarity of illustration. However, the mask 10 may contact the transfer arm 19 as the sensors 32a, 32b, 32c are depressed into associated cavities by the mask 10. The transfer arm 19 should be positioned so that the retaining plane 50 is parallel to the support plane 52 defined by the front surface of the platen 13. As the transfer arm 19 is extended in this position to contact the mask 10, the sensors 32a, 32b, 32c are simultaneously activated when they contact the blocking portion 17 of the mask 10. Therefore, the surface 302 of the mask 10 is parallel to the retaining plane 50 indicating the mask 10 is properly positioned in the masking position. The controller 60 may then receive a signal from the sensors 32a, 32b, 32c representative of proper mask positioning and may enable further processing, e.g., implantation of ions, to take place with the assurance of the properly positioned mask.

FIG. 4C illustrates an example of the transfer arm 19 extended to the mask 10 when the mask 10 is not in a proper masking position. In this instance, the surface 302 of the mask 10 is not parallel to the retaining plane 50 so the three sensors 32a, 32b, 32c are not simultaneously activated when the transfer arm 19 contacts the mask 10. The controller 60 may then receive a signal from the sensors 32a, 32b, 32c representative of an improper masking position. The controller 60 may then instruct components to take corrective action including, but not limited to, preventing ion implantation until the mask is in the proper masking position, attempting to reposition the mask in the proper masking position, and activating an alarm to notify a user after one or more unsuccessful attempts to position the mask in the proper masking position.

In another embodiment, the three sensors 32a, 32b, 32c are included on a separate mechanism from the mask transport system 2. This separate mechanism may be another transfer arm. It may advance or retract to activate sensors 32a, 32b, 32c and may be stored to the side of the platen 13. In other embodiments, this separate transfer arm may be disposed on the platen 13 or a mechanical scanner and translated to test whether the mask 10 is properly positioned relative to a retaining plane defined by the transfer arm.

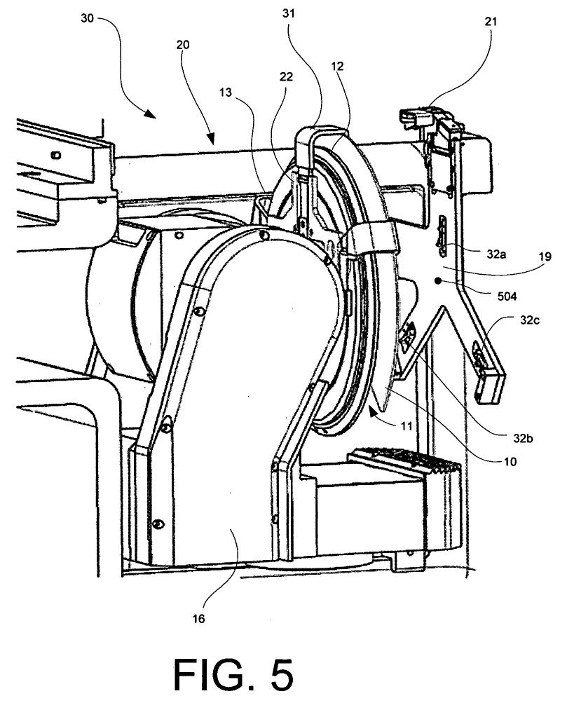

Turning to FIG. 5, a perspective view of one mask position detection apparatus 30 consistent with an embodiment is illustrated. Like components of FIG. 5 are labeled similarly as previous embodiments and hence any repetitive description is omitted herein for clarity. The mask 10 is illustrated in the masking position. The mask 10 may have at least one finger 31 that engages with a corresponding portion of the mask retaining element 22 of the platen 13. A workpiece handling system may reposition the workpiece 12 on the platen 13 to allow different areas of the workpiece 12 to be implanted with ions through the aperture 11 in the mask. In other embodiments, the mask 10 is changed, reoriented, or moved for another implant.

The platen 13 is supported by the mechanical scanner 16. The mechanical scanner 16 may translate the workpiece 12 in one or two dimensions depending on the architecture of the ion implanter to distribute ions 15 over the front surface of workpiece 12. The mechanical scanner 16 may also tilt the platen 13 around a horizontal axis for angled implants or may rotate the platen 13 about a horizontal axis to a workpiece load/unload position. Additionally, the mechanical scanner 16 may translate platen 13 vertically during ion implantation. The mechanical scanner 16 may also move platen 13 upwardly with respect to mask 10 so that mask 10 or at least one finger 31 on the mask 10 may engage an associated mask retaining element 22.

The transfer arm 19 is driven by the drive system 20. The transfer arm 19 includes at least one retaining element 21 for engaging the mask during transport of the mask 10 between different positions. The three sensors 32a, 32b, 32c, may be radially disposed from a center 504 of the transfer arm a similar distance. The sensors 32a, 32b, 32c may also be disposed at a similar angle from each other with respect to the center 504 to form an equilateral triangle when joined by three lines.

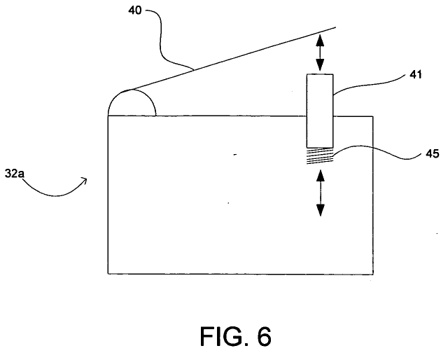

Turning to FIG. 6, an embodiment of a sensor 32a is illustrated where the sensor is an electrical switch. The switch 32a may have a first member 40 that is flexible or coupled to a hinge. The first member 40 when contacted by another body such as the mask 10 may be translated towards the second member 41. The second member 41 may be biased by a spring 45. When the first member 40 is translated towards the second member 41 it may urge the second member against the bias of the spring to switch states of the switch 32a. The states may switch is successive fashion from closed to open positions when activated by contact. In one embodiment, the electrical switch may be a sub-miniature snap-action switch.

Accordingly, there is provided a transfer arm defining a retaining plane with at least three sensors disposed on the transfer arm and configured to detect a position of a mask relative to the retaining plane. The at least three sensors may be used to determine if the mask is properly positioned on the transfer arm for transport. Therefore, inadvertent disengagement of the mask from the transfer arm during transport can be minimized preventing damage to workpieces. In addition, proper positioning of the mask on the transfer arm can improve the likelihood of successfully placing the mask in other positions. The at least three sensors may also be used to determine if the mask is properly positioned in a masking position. Accordingly, implantation of ions with the mask in an improper masking position may be avoided thus minimizing deviation from an intended implant area.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the foregoing description is by way of example only and is not intended as limiting.

What is claimed is:

1. A system comprising:
a transfer arm defining a retaining plane; and
at least three sensors disposed on said transfer arm and configured to detect a position of a mask relative to said retaining plane.

2. The system of claim 1, wherein said at least three sensors are simultaneously activated when said mask is initially retained on said transfer arm if a surface of said mask is parallel to said retaining plane thereby indicating said mask is properly positioned on the transfer arm.

3. The system of claim 1, wherein said at least three sensors are not simultaneously activated when said mask is initially retained on said transfer arm if a surface of said mask is not parallel to said retaining plane thereby indicating said mask is not properly positioned on the transfer arm.

4. The system of claim 1, further comprising:
a drive system configured to drive said transfer arm to transport said mask to a masking position relative to a platen, and wherein said drive system is further configured to retract said transfer arm after positioning said mask in said masking position and then to extend said transfer arm to said mask to determine if said mask is properly positioned in said masking position.

5. The system of claim 4, wherein said transfer arm is positioned with said retaining plane parallel to a support plane defined by said platen when said transfer arm is extended to said mask, and wherein said at least three sensors are simultaneously activated when a surface of said mask is parallel to said retaining plane thereby indicating said mask is properly positioned in said masking position.

6. The system of claim 4, wherein said transfer arm is positioned with said retaining plane parallel to a support plane defined by said platen when said transfer arm is extended to said mask, and wherein said at least three sensors are not simultaneously activated when a surface of said mask is not parallel to said retaining plane thereby indicating said mask is not properly positioned in said masking position.

7. An ion implanter comprising:
an ion generator configured to generate ions and direct said ions towards a workpiece;
a platen configured to support said workpiece;
a transfer arm defining a retaining plane; and
at least three sensors disposed on said transfer arm and configured to detect a position of a mask relative to said retaining plane.

8. The ion implanter of claim 7, wherein said at least three sensors are not simultaneously activated when said mask is initially retained on said transfer arm if a surface of said mask is not parallel to said retaining plane thereby indicating said mask is not properly positioned on the transfer arm.

9. The ion implanter of claim 7, further comprising
a drive system configured to drive said transfer arm to transport said mask to a masking position relative to a platen, and wherein said drive system is further configured to retract said transfer arm after positioning said mask in said masking position and then to extend said transfer arm to said mask to determine if said mask is properly positioned in said masking position.

10. The ion implanter of claim 9, wherein said transfer arm is positioned with said retaining plane parallel to a support plane defined by said platen when said transfer arm is extended to said mask, and wherein said at least three sensors are not simultaneously activated when a surface of said mask is not parallel to said retaining plane thereby indicating said mask is not properly positioned in said masking position.

11. A method comprising:
transporting a transfer arm defining a retaining plane into contact with a mask, said transfer arm having at least three sensors disposed thereon; and
monitoring a condition of said at least three sensors to detect a position of said mask relative to said retaining plane.

12. The method of claim 11, further comprising:
retaining said mask on said transfer arm for transport, wherein said at least three sensors are simultaneously activated when said mask is initially retained on said transfer arm if a surface of said mask is parallel to said retaining plane thereby indicating said mask is properly positioned on the transfer arm.

13. The method of claim 11, further comprising:
retaining said mask on said transfer arm for transport, wherein said at least three sensors are not simultaneously activated when said mask is initially retained on said transfer arm if a surface of said mask is not parallel to said retaining plane thereby indicating said mask is not properly positioned on the transfer arm.

14. The method of claim 11, further comprising:
transporting said transfer arm retaining said mask from a non-masking position to a masking position relative to a platen;
retracting said transfer arm from said mask; and
extending said transfer arm to contact said mask to determine if said mask is properly positioned in said masking position.

15. The method of claim 14, further comprising;
positioning said transfer arm with said retaining plane parallel to a support plane defined by said platen when extending said transfer arm to contact said mask, wherein said at least three sensors are simultaneously activated when a surface of said mask is parallel to said retaining plane thereby indicating said mask is properly positioned in said masking position.

16. The method of claim 14, further comprising;
positioning said transfer arm with said retaining plane parallel to a support plane defined by said platen when extending said transfer arm to contact said mask, wherein said at least three sensors are not simultaneously activated when a surface of said mask is not parallel to said retaining plane thereby indicating said mask is not properly positioned in said masking position.
